(19) United States
(12) Patent Application Publication
(10) Pub. No.: US 2015/0332848 A1
(43) Pub. Date: Nov. 19, 2015

(54) COIL FOR NON-CONTACT POWER TRANSMISSION SYSTEM AND NON-CONTACT POWER TRANSMISSION SYSTEM

(71) Applicant: Panasonic Intellectual Property Management Co., Ltd., Osaka (JP)

(72) Inventors: Atsushi FUJITA, Shiga (JP); Hideki SADAKATA, Shiga (JP); Yoshiharu OMORI, Shiga (JP); Hiroaki KURIHARA, Shiga (JP); Daisuke BESSYO, Shiga (JP)

(21) Appl. No.: 14/813,046

(22) Filed: Jul. 29, 2015

Related U.S. Application Data
(63) Continuation of application No. PCT/JP2014/000440, filed on Jan. 29, 2014.

(30) Foreign Application Priority Data
Jan. 30, 2013 (JP) 2013-015074

(51) Int. Cl. H01F 38/14; H01F 27/24; H01F 27/28; H02J 5/00

(52) U.S. Cl. CPC H01F 38/14; H02J 5/005; H01F 27/24; H01F 27/2823

(57) ABSTRACT

A coil for a non-contact power transmission system according to the present disclosure is used in a non-contact power transmission system to transmit electric power via a non-contact method. The coil includes a magnetic body with a flat cross section, and a wire wound around the magnetic body. The wire is wound around a shorter side surface of the magnetic body at a predetermined angle with respect to a direction perpendicular to a longer side surface of the magnetic body.

### CROSS-REFERENCE TO RELATED APPLICATIONS

This is a continuation of International Application No. PCT/JP2014/000440 filed on Jan. 29, 2014, which claims priority to Japanese Patent Application No. 2013-015074 filed on Jan. 30, 2013. The entire disclosures of these applications are incorporated by reference herein.

### BACKGROUND

The present disclosure relates to coils for non-contact power transmission systems for use in, for example, charging electric propulsion vehicles such as electric vehicles and plug-in hybrid vehicles.

A non-contact power transmission system includes, for example, as shown in FIGS. 7A, 7B, and 8, a power supplier 101 including a coil 150 wound around an H-shaped core 140, and a power receiver 102. The power supplier 101 faces the power receiver 102 with an air gap interposed therebetween (see, e.g., Japanese Patent Publication No. 2011-50127).

In place of the H-shaped core 140, a rectangular the core 170 may be used as shown in FIGS. 9A and 9B.

### SUMMARY

A coil used in a non-contact power transmission system used for, for example, charging an electric propulsion vehicle (e.g., a power receiving coil mounted on a vehicle, in particular) needs to have a reduced thickness to avoid contact with an interfering object (e.g., a car stop, a block) on a road surface. The height of a vehicle changes, for example, when a driver or passenger gets in and out of the vehicle, or a luggage is loaded and unloaded into/from the vehicle. If the power supplier accidentally contacts with the power receiver due to a change in the height of the vehicle, there is a risk that the power supplier or the power receiver could be damaged. In order to keep a certain air gap between the power supplier and the power receiver, the coil for the non-contact power transmission system also needs to have its thickness reduced.

However, in FIG. 7A, for example, when the coil 150 is wound around the H-shaped core 140 with a reduced thickness, a bending portion of the coil 150 has an increased curvature on a shorter side surface in a transverse cross-section of the core 140. In general, in a non-contact power transmission system, an RF current is supplied to the coil 150 to generate an RF magnetic field, thereby enabling high-efficiency power transmission. As the coil 150, very fine stranded wires (e.g., Litz wires), which are insulated from each other, are used to reduce heat generation caused by an increase in the resistance.

With an increase in curvature at the bending portion of the coil 150, the Litz wire could be broken or its insulating film could be damaged. As a result, heat generation due to an increase in the resistance of the coil 150 can no longer be reduced sufficiently, thus increasing the temperature of the coil 150, which may lead to malfunction of the non-contact power transmission system.

In view of the foregoing background, it is therefore an objective of the present disclosure to provide a coil with a reducible thickness for a non-contact power transmission system.

A coil for a non-contact power transmission system according to the present disclosure is used in a non-contact power transmission system to transmit electric power via a non-contact method. The coil includes a magnetic body with a flat cross section, and a wire wound around the magnetic body. The wire is wound around a shorter side surface of the magnetic body in transverse cross-section at a predetermined angle with respect to a direction perpendicular to a longer side surface of the magnetic body in a longitudinal cross-section.

According to the present disclosure, when the wire is wound around the magnetic body, the wire around the shorter side surface of the magnetic body in the transverse cross-section, which is an easily bendable portion, may be set to be equal to or greater than a predetermined length, thereby reducing bending of the wire. As a result, a coil with a reduced thickness is provided for a non-contact power transmission system without breaking the wire or damaging its insulating film.

### BRIEF DESCRIPTION OF THE DRAWINGS

FIGS. 1A-1C generally illustrate a coil for a non-contact power transmission system according to an embodiment of the present disclosure.

FIG. 2 is an enlarged cross-sectional view of a wire according to the present disclosure.

FIGS. 3A-3C generally illustrate winding states of a wire according to the present disclosure.

FIGS. 4A-4C generally illustrate a coil for a non-contact power transmission system according to another embodiment of the present disclosure.

FIGS. 5A-5C generally illustrate a coil for a non-contact power transmission system according to yet another embodiment of the present disclosure.

FIGS. 6A-6C generally illustrate a coil for a non-contact power transmission system according to still another embodiment of the present disclosure.

FIGS. 7A and 7B illustrate an H-shaped core of a coil of a conventional non-contact power supplier.

FIG. 8 illustrates a power supplier and a power receiver facing the power supplier in a conventional non-contact power supplier.

FIGS. 9A and 9B illustrate a rectangular core in a conventional non-contact power supplier.

### DETAILED DESCRIPTION

A coil for a non-contact power transmission system according to an embodiment of the present disclosure is a power transmitting coil or a power receiving coil used in a non-contact power transmission system to transmit electric power via a non-contact method. The coil includes a magnetic body with a flat cross section, and a wire wound around the magnetic body. The wire is wound around a shorter side surface of the magnetic body in transverse cross-section at a predetermined angle other than 90 degrees with respect to a longer side surface of the magnetic body in a longitudinal cross-section.

With this configuration, when a wire is wound around a magnetic body, the length of the wire at the shorter side surface of the magnetic body in the transverse cross-section, which is an easily bendable portion, may be set to be equal to or greater than a predetermined length, thereby reducing bending of the wire. As a result, a coil with a reduced thickness is provided for a non-contact power transmission system without breaking the wire or damaging its insulating film.

### EMBODIMENTS

Embodiments of the present disclosure will now be described with reference to the drawings. Note that the following description of embodiments is not intended to limit the scope of the present disclosure.

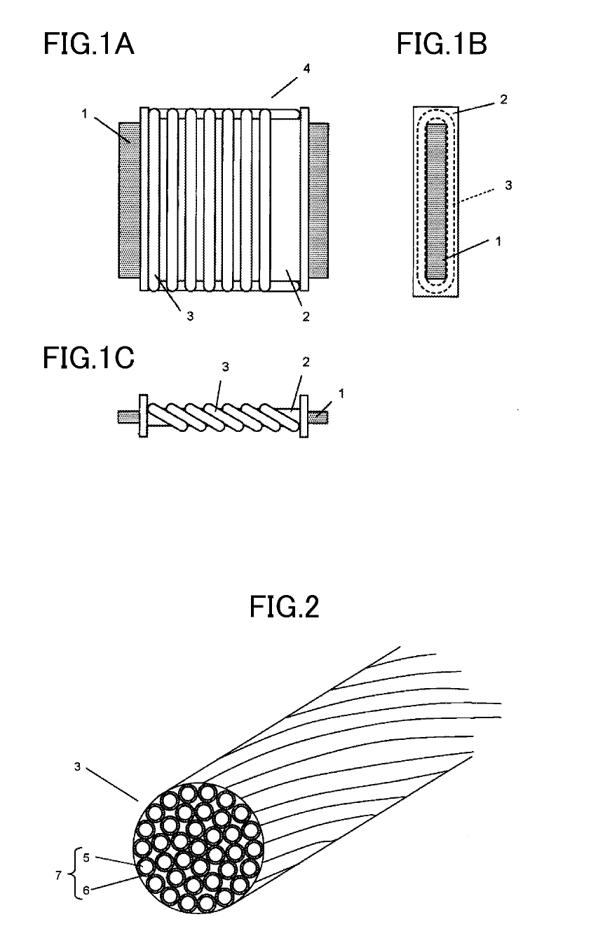

FIGS. 1A-1C generally illustrate a coil for a non-contact power transmission system according to an embodiment of the present disclosure. FIG. 1A is a top view. FIG. 1B is a side view as viewed along a winding axis of a coil. FIG. 1C is a side view as viewed in the direction perpendicular to the winding axis of the coil.

As shown in FIG. 1A, a bobbin 2 is disposed around a magnetic body 1. The magnetic body 1 is formed to have a flat cross section by arranging a plurality of ferrite elements. The bobbin 2 is made of an electrically insulating resin. A wire 3 is wound around the magnetic body 1 with the bobbin 2 interposed therebetween.

The magnetic body 1 and the wire 3 together function as an inductive coil 4. When a current flows through the wire 3, a magnetic flux is generated from the magnetic body 1 along the winding axis of the coil (i.e., in the lateral direction) in FIG. 1A. In the non-contact power transmission system, this coil 4 is provided as a power transmitting coil and a power receiving coil so that the coils face each other.

FIG. 2 is an enlarged cross-sectional view of the wire 3. A Litz wire formed by stranding a large number of element wires 7 is used as the wire 3. Each element wire 7 is comprised of a conductor 5 and an insulator 6. The conductor 5 is configured, for example, as a copper wire. The insulator 6 is, for example, an epoxy layer on the surface of the conductor 5. The Litz wire sufficiently reduces the resistance to be produced when an RF current flows through the wire and thereby reduce heat generation. An RF current is supplied from a power supply (not shown) to the wire 3 of the power transmitting coil. An RF magnetic field generated by the power transmitting coil is magnetically coupled to a power receiving coil 4, which faces the power transmitting coil, thereby enabling high-efficiency power transmission.

In general, when an RF current flows through the wire 3, the current may concentrate on the surface of the conductor 5 (i.e., skin effect). Or a current flowing between adjacent ones of the conductors 5 may generate such a magnetic field that causes non-uniform current distribution (i.e., proximity effect). However, the wire 3 implemented as a Litz wire mitigates such skin effect and proximity effects, thereby reducing an increase in the resistance.

However, the conductors 5 constituting such a Litz wire are extremely fine. The insulators 6 are also extremely thin layers. For these reasons, when the wire 3 is handled in a bent state, there is a risk that the conductors 5 could be broken or the insulators 6 could be damaged or peeled off to eventually cause an increase the resistance of the wire 3.

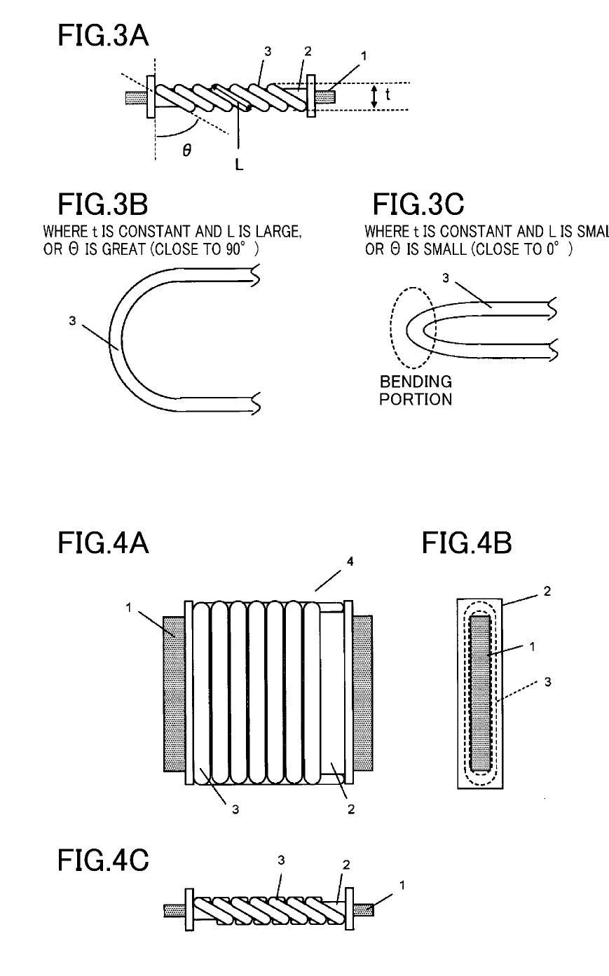

Similar to FIG. 1C, FIG. 3A is a side view as viewed in the direction perpendicular to the winding axis of the coil 4. L denotes the length of the wire 3 wound around the short side surface of the magnetic body 1. θ denotes an angle defined by the wire 3 with respect to the direction perpendicular to the longer side surface of the magnetic body 1. t denotes the winding thickness of the wire 3 (≈the thickness of the bobbin 2). The magnetic body 1 has a substantially rectangular flat cross-section. The shorter side surface of the magnetic body 1 is one of the side surfaces parallel to the winding axis of the coil 4, and has a width defined by a shorter side of the cross-section of the magnetic body 1. The longer side surface of the magnetic body 1 has a width defined by a longer side of the cross-section of the magnetic body 1.

If the wire 3 is wound at a small angle θ, in other words, if the wire 3 is wound to approach the line perpendicular to the shorter side surface of the magnetic body 1, L decreases (≈t), the bending radius of the wire 3 also decreases as shown in FIG. 3C to cause a bending portion. As a result, the conductors 5 could be broken or the insulators 6 could be damaged or peeled off.

In this embodiment, if the wire 3 is wound at a great angle θ, in other words, if the wire 3 is wound to increase L, the wire 3 comes to have a large bending radius as shown in FIG. 3B.

In this embodiment, being wound at a great angle θ and with an increased L with respect to t, the wire 3 may be wound to have a large bending radius. This allows for reducing breakage of the conductors 5 and damages and peeling of the insulators 6 and thereby maintaining high reliability.

The wire 3 implemented as a Litz wire reduces an increase in the resistance so much as to minimize heat generation at the coil 4. Consequently, high-efficiency power transmission is realized.

Since this coil for the non-contact power transmission system for use in, for example, charging an electric propulsion vehicle has a reducible thickness, contact with an interfering object (e.g., a car stop, a block) on a road surface is avoidable. Such a reduction in the thickness also minimizes damages of the power transmitting or receiving coil. This is because this coil does not contact with the power transmitting or receiving coil easily even if the height of a vehicle provided with the coil changes when a driver or passenger gets in or out of the vehicle or when a luggage is loaded or unloaded into/from the vehicle.

The allowable bending radius and bending tolerance range of the insulators 6 of the Litz wire vary depending on the thickness, material, heat resistance, or other factors, which also affects the specification of the wire 3. The winding angle θ of the wire 3 may be set in accordance with the specification of the wire 3 such that the wire 3 falls within the bending tolerance range not damaging the insulators 6. In this embodiment, the winding angle θ of the wire 3 preferably falls within a range from 10 to 60 degrees, and more preferably falls within a range from 30 to 60 degrees.

In this embodiment, as shown in FIGS. 1A-1C, an example has been described where the wire 3 is wound with a substantially constant outside diameter, and with a gap interposed between turns of the wire 3. The configuration is however only an example and no way limiting. For example, as shown in FIGS. 4A-4C, if the wire 3 is wound while being deformed to be flat on longer side surfaces of the coil 4, in the height of the wire 3 is reduced, thereby further reducing the thickness of the coil 4.

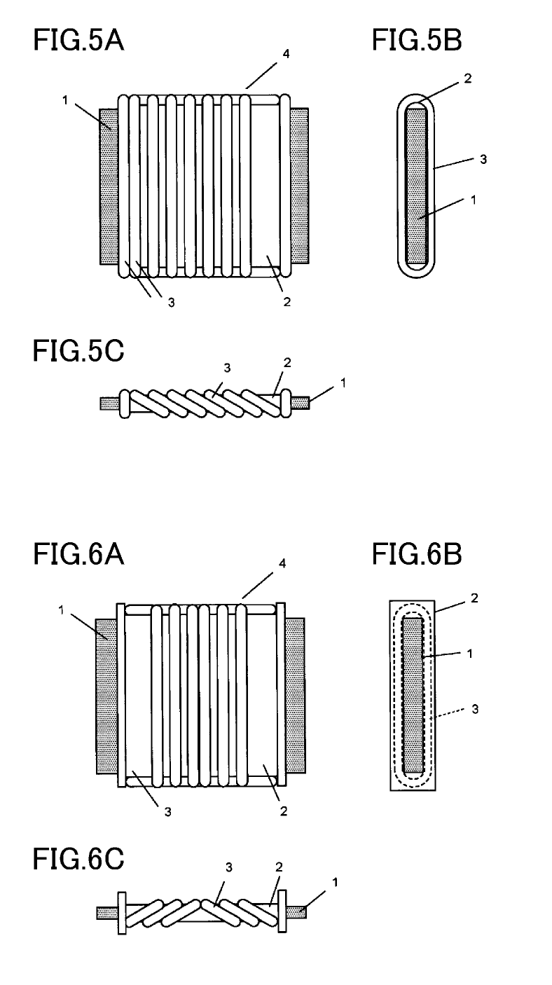

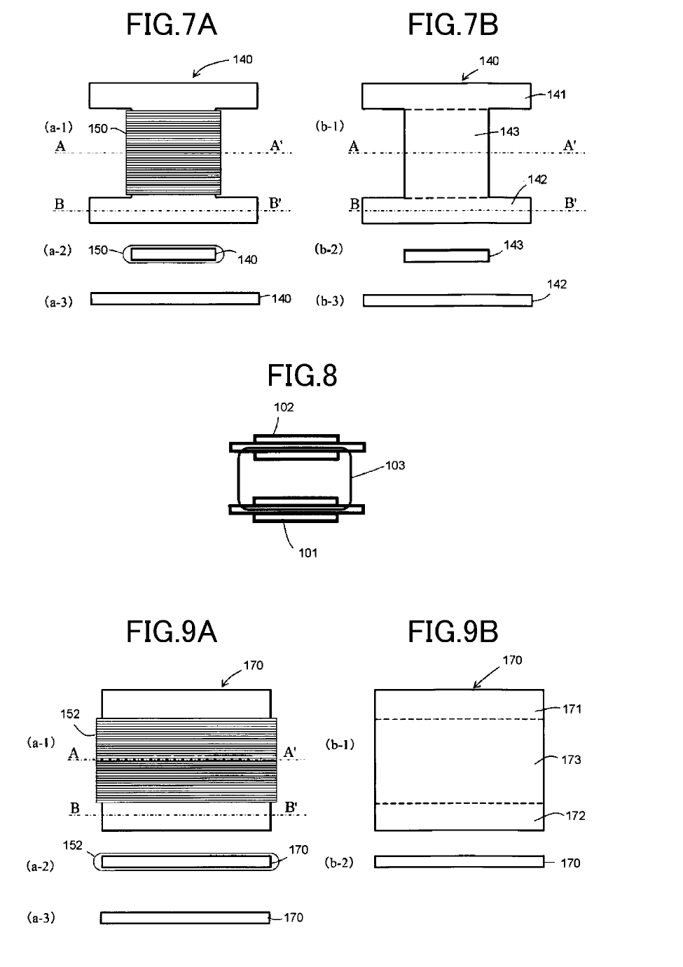

In this embodiment, as shown in FIGS. 1C and 3A, an example has been described where the wire 3 is wound at a constant winding angle θ on a shorter side surface of the coil 4. The configuration is however only an example and no way limiting. For example, as shown in FIGS. 5A-5C, at both ends of the bobbin 2, the wire 3 wound around the shorter side surface of the magnetic body 1 in the transverse cross section may be wound substantially perpendicularly to the longer side surface of the magnetic body 1 in the longitudinal cross-section. As a result, the ends of the wire 3 are more readily fixed to reduce deviation and deformation of the wire 3. The wire 3 may be wound only at one end. The winding angle of the wire 3 may be changed only where needed depending on the purpose such as reduction in deviation or shape retention of the wire 3.

Alternatively, as shown in FIGS. 6A-6C, the winding angle of the wire 3 may be changed on the way. When the coil 4 is used as a power transmitting or receiving coil for a non-contact power transmission system, an opening formed at each end of the wound wire 3 is oriented to the other coil that faces the former coil. Then, the magnetic field generated from the end of the wire 3 is more easily oriented toward the other coil, which thus improves transmission efficiency and reduces the leakage magnetic field.

The coil 4 according to this embodiment may be used as one or both of coils set on the ground and in a vehicle. The coil on the ground transmits electric power, while the coil on the vehicle receives the electric power. In particular, the coil on the vehicle is often desired to have a reduced thickness to avoid interference with a road surface. Therefore, the coil 4 of this embodiment may be used only as a coil on the vehicle side.

The present disclosure is applicable for use as a power transmitting or receiving coil for a non-contact power transmission system at the time in, for example, charging an electric propulsion vehicle such as an electric vehicle and a plug-in hybrid vehicle.

What is claimed is:

1. A coil for use in a non-contact power transmission system to transmit electric power via a non-contact method, the coil comprising:
a magnetic body with a flat cross section; and
a wire wound around the magnetic body, wherein
the wire is wound around a shorter side surface of the magnetic body at a predetermined angle with respect to a direction perpendicular to a longer side surface of the magnetic body.

2. The coil for the non-contact power transmission system of claim 1, wherein
a surface of the wire is covered with an insulator, and
on the short side surface of the magnetic body, the predetermined angle falls within a bending tolerance range in which the insulator is not damaged.

3. The coil for the non-contact power transmission system of claim 1, wherein
the predetermined angle falls within a range from 10 to 60 degrees.

4. A non-contact power transmission system comprising:
a power supplier including a power transmitting coil; and
a power receiver including a power receiving coil, wherein
the power transmitting coil and/or the power receiving coil are/is the coil for the non-contact power transmission system of claim 1.
